(19) United States
(12) Patent Application Publication
(10) Pub. No.: US 2007/0014683 A1
(43) Pub. Date: Jan. 18, 2007

(54) Hydrogen storage composition, and associated article and method

(75) Inventors: Ji-Cheng Zhao, Latham, NY (US); John Patrick Lemmon, Schoharie, NY (US); Susan Holt Townsend, Niskayuna, NY (US); William Paul Minnear, Clifton Park, NY (US); Luke Natheniel Brewer, Albuquerque, NM (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/522,251

(22) Filed: Sep. 15, 2006

Related U.S. Application Data
(63) Continuation-in-part of application No. 10/675,109, filed on Sep. 30, 2003, now Pat. No. 7,115,245.
(63) Continuation-in-part of application No. 10/675,360, filed on Sep. 30, 2003, now Pat. No. 7,115,246.
(63) Continuation-in-part of application No. 10/675,402, filed on Sep. 30, 2003, now Pat. No. 7,115,247.
(63) Continuation-in-part of application No. 10/675,401, filed on Sep. 30, 2003, now Pat. No. 7,115,244.
(63) Continuation-in-part of application No. 10/747,838, filed on Dec. 29, 2003.

(51) Int. Cl. C01B 31/30; C22C 23/02; C22C 21/06; C22C 24/00

(52) U.S. Cl. 420/400; 423/439; 423/289; 420/407; 420/542; 420/900

(57) ABSTRACT

A composition that includes a storage material is provided. The storage material includes at least one of AlLi, Al₂Li₃, Al₄Li₉, Al₃Mg₂, Al₁₂Mg₁₇, AlB₁₂, Al₄C₃, AlTi₂C, AlTi₃C, AlZrC₂, Al₃Zr₅C, Al₃Zr₂C₄, Al₃Zr₂C₇, AlB₂, AlB₁₂, AlSi, B₆Ca, B₆K, B₁₂Li, B₆Li, B₄Li, B₃Li, B₂Li, BLi, B₆Li₇, BLi₃, Ca₂Si, CaSi, CaSi₂, Ge₄K, GeK, GeK₃, GeLi₃, Ge₅Li₂₂, Mg₂Ge, Ge₄Na, GeNa, GeNa₃, KSi, KC₄, K₄Si₂₃, K₄C₃, LiC, Li₄C₃, LiC₆, Li₂₂Si₅, Li₁₃Si₄, Li₇Si₃, Li₁₂Si₇, MgB₂, MgB₄, MgB₇, MgC₂, Mg₂C₃, Mg₂Si, NaB₆, NaB₁₅, NaB₁₆, Na₄C₃, NaC₄, NaSi, NaSi₂, or Na₄Si₂₃. An article including the storage material, and a system including the article are also provided.

### CROSS-REFERENCE TO RELATED APPLICATIONS

This application may be about a continuation-in-part of U.S. patent application Ser. No. 10/675109 [134082] filed on Sep. 30, 2003; and of U.S. patent application Ser. No. 10/675,360 [134083] filed on Sep. 30, 2003; and of U.S. patent application Ser. No. 10/675,402 [134122] filed on Sep. 30, 2003; and of U.S. patent application Ser. No. 10/675,401 [134123] filed on Sep. 30, 2003; and of U.S. patent application Ser. No. 10/747,838 [133456] filed on Dec. 29, 2003. The contents of the foregoing are hereby incorporated by reference in their entirety, to include drawings.

### TECHNICAL FIELD

The invention includes embodiments that relate to compositions capable of storing hydrogen. The invention includes embodiments that relate to articles including compositions capable of storing hydrogen. The invention includes embodiments that relate to methods of making and using articles and compositions capable of storing hydrogen.

### DISCUSSION OF RELATED ART

Several methods of storing hydrogen currently are available, but these may be either inadequate or impractical in some applications. Hydrogen can be stored in liquid form at very low temperatures. However, the energy consumed in liquefying hydrogen gas may be about 40 percent of the energy available from the resulting hydrogen. A standard tank filled with liquid hydrogen may empty in about a week through evaporation alone; thus, dormancy may be a problem. These factors make liquid hydrogen impractical for some applications.

Regardless of temperature, hydrogen may be stored under high pressure in cylinders. However, a 45 kilogram pound steel cylinder can store only about 154 kilogram/square centimeter (kg/cm²) of hydrogen at about 2200 psi. This translates to about 1 weight percent of hydrogen storage. Composite cylinders with special compressors can store hydrogen at higher pressures of about 4,500 psi to achieve a more favorable storage ratio of about 4 percent by weight. The use of composites for high pressure storage may have some undesirable features.

Hydrogen can be stored in several types of solid-state materials. The reversible storage of hydrogen in solid-state materials depends on thermodynamic and kinetic properties of the storage material to absorb, dissociate, and react reversibly with hydrogen to form the hydrogen storage material. There may be several modes and mechanisms by which hydrogen may be stored if the chemical potentials and kinetics are favorable toward hydriding, complexation or hydrogen sorption. In some cases alloying or forming composite materials can alter the thermodynamics of potential hydrogen storage materials. Also, “doping” into hydrogen storage materials may affect the reaction rate and activation energy for a reversible hydrogen storage reaction. The storage of hydrogen using certain metal hydride compounds may be hampered by such factors as, for example, the efficiency of the compound to store hydrogen, the economics and practicability of obtaining raw material or producing the compound, and the conditions under which hydrogen may be stored.

It would desirable to have compositions for storing hydrogen that differ from those compositions currently available. It would be desirable for those compositions to have properties, features, or attributes that differ from those of the compounds currently available. It would desirable to have articles including compositions for storing hydrogen that differ from those articles currently available. It would desirable to have methods of making compositions or articles for storing hydrogen, or of using compositions or articles for storing hydrogen, that differ from those compositions currently available.

### BRIEF DESCRIPTION

An embodiment of the invention includes a composition that includes a storage material. The storage material includes at least one of AlLi, Al₂Li₃, Al₄Li₉, Al₃Mg₂, Al₁₂Mg₁₇, AlB₁₂, Al₄C₃, AlTi₂C, AlTi₃C, AlZrC₂, Al₃Zr₅C, Al₃Zr₂C₄, Al₃Zr₂C₇, AlB₂, AlB₁₂, AlSi, B₆Ca, B₆K, B₁₂Li, B₆Li, B₄Li, B₃Li, B₂Li, BLi, B₆Li₇, BLi₃, Ca₂Si, CaSi, CaSi₂, Ge₄K, GeK, GeK₃, GeLi₃, Ge₅Li₂₂, Mg₂Ge, Ge₄Na, GeNa, GeNa₃, KSi, KC₄, K₄Si₂₃, K₄C₃, LiC, Li₄C₃, LiC₆, Li₂₂Si₅, Li₁₃Si₄, Li₇Si₃, Li₁₂Si₇, MgB₂, MgB₄, MgB₇, MgC₂, Mg₂C₃, Mg₂Si, NaB₆, NaB₁₅, NaB₁₆, Na₄C₃, NaC₄, NaSi, NaSi₂, or Na₄Si₂₃.

In one embodiment, an article includes a storage material. The storage material may include one or more material having a formula selected from the group consisting of formulae (I), (II), (III), (IV) and (IV), wherein:
(Liₐ, Na_{b}, K_{c}, Al_{d}, Mgₑ, Ca_{f})ₓ(B)_{y} (I)
(Liₐ, Na_{b}, K_{c}, Al_{d}, Mgₑ, Ca_{f})ₓ(C)_{y} (II)
(Liₐ, Na_{b}, Mg_{c}, K_{d}, Caₑ, Ge_{f})ₓ(Al)_{y} (III)
(Liₐ, Na_{b}, Mg_{c}, K_{d}, Caₑ, Al_{f})ₓ(Ge)_{y} (IV)
(Liₐ, Na_{b}, K_{c}, Al_{d}, Mgₑ, Ca_{f})ₓ(N, Si)_{y} (V)
where Al is aluminum, B is boron, C is carbon, Ca is calcium, Ge is germanium, K is potassium, Li is lithium, Mg is magnesium, Na is sodium, N is nitrogen, and Si is silicon; a, b, c, d, e and f are the same or different from each other, and each independently have a value 0 or 1, provided that the sum a+b+c+d+e+f is 1 or greater; and x and y each independently have a value in a range of from 1 to about 22.

In one embodiment, a system includes a storage article. The storage article may include a storage material selected from the group consisting of AlLi, Al₂Li₃, Al₄Li₉, Al₃Mg₂, Al₁₂Mg₁₇, AlB₁₂, Al₄C₃, AlTi₂C, AlTi₃C, AlZrC₂, Al₃Zr₅C, Al₃Zr₂C₄, Al₃Zr₂C₇, AlB₂, AlB₁₂, AlSi, B₆Ca, B₆K, B₁₂Li, B₆Li, B₄Li, B₃Li, B₂Li, BLi, B₆Li₇, BLi₃, Ca₂Si, CaSi, CaSi₂, Ge₄K, GeK, GeK₃, GeLi₃, Ge₅Li₂₂, Mg₂Ge, Ge₄Na, GeNa, GeNa₃, KSi, KC₄, K₄Si₂₃, K₄C₃, LiC, Li₄C₃, LiC₆, Li₂₂Si₅, Li₁₃Si₄, Li₇Si₃, Li₁₂Si₇, MgB₂, MgB₄, MgB₇, MgC₂, Mg₂C₃, Mg₂Si, NaB₆, NaB₁₅, NaB₁₆, Na₄C₃, NaC₄, NaSi, NaSi₂, and Na₄Si₂₃. The system may include a detector, a desorption device, or both.

### DETAILED DESCRIPTION

The invention includes embodiments that relate to compositions capable of storing hydrogen, i.e., storage materials. The invention includes embodiments that relate to articles including compositions capable of storing hydrogen. The invention includes embodiments that relate to methods of making and using articles and compositions capable of storing hydrogen.

Approximating language, as used herein throughout the specification and claims, may be applied to modify any quantitative representation that could permissibly vary without resulting in a change in the basic function to which it may be about related. Accordingly, a value modified by a term such as “about” is not limited to the precise value specified. In some instances, the approximating language may correspond to the precision of an instrument for measuring the value.

Compositions according to various embodiments of the invention may be grouped as aluminum-containing, boron-containing, carbon-containing, germanium-containing, and silicon-containing storage materials. In one embodiment, the compositions may include aluminides, borides, carbides, germanides, and silicides, or a combination of two or more thereof. The groups each include one or more compositions that may be embodiments of the invention. These compositions may include one type of composition from one group, may include two or more compositions from one group, or may include two or more compositions from two or more groups. Further, some embodiments may include only one type of composition from one group, may include only two or more compositions from one group, or may include only two or more compositions from two or more groups. That is, each composition listed may be used to the exclusion of other materials, or may consist essentially of the composition.

Suitable aluminum-containing compositions may include one or more of AlLi, Al₂Li₃, Al₄Li₉, Al₃Mg₂, Al₁₂Mg₁₇, AlB₁₂, Al₄C₃, AlTi₂C, AlTi₃C, AlZrC₂, Al₃Zr₅C, Al₃Zr₂C₄, Al₃Zr₂C₇, AlB₂, AlB₁₂, and AlSi.

Suitable boron-containing compositions may include one or more of AlB₂, AlB₁₂, B₆Ca, B₆K, B₁₂Li, B₆Li, B₄Li, B₃Li, B₂Li, BLi, B₆Li₇, BLi₃, MgB₂, MgB₄, MgB₇, NaB₆, NaB₁₅, and NaB₁₆.

Suitable carbon-containing compositions may include one or more of Al₄C₃, Na₄C₃, Li₄C₃, K₄C₃, LiC, LiC₆, Mg₂C₃, MgC₂, AlTi₂C, AlTi₃C, AlZrC₂, Al₃Zr₅C, Al₃Zr₂C₄, Al₃Zr₂C₇, KC₄, and NaC₄.

Suitable germanium-containing compositions may include one or more of Ge₄K, GeK, GeK₃, GeLi₃, Ge₅Li₂₂, Mg₂Ge, Ge₄Na, GeNa, and GeNa₃.

Suitable silicon-containing compositions may include one or more of AlSi, Ca₂Si, CaSi, CaSi₂, KSi, K₄Si₂₃, Li₂₂Si₅, Li₁₃S₄, Li₇Si₃, Li₁₂Si₇, Mg₂Si, NaSi, NaSi₂, and Na₄Si₂₃.

In one embodiment, the storage material includes one or more of AlLi, Al₂Li₃, Al₄Li₉, Al₃Mg₂, Al₁₂Mg₁₇, AlB₁₂, Al₄C₃, AlTi₂C, AlTi₃C, AlZrC₂, Al₃Zr₅C, Al₃Zr₂C₄, Al₃Zr₂C₇, AlB₂, AlB₁₂, AlSi, B₆Ca, B₆K, B₁₂Li, B₆Li, B₄Li, B₃Li, B₂Li, BLi, B₆Li₇, BLi₃, MgB₂, MgB₄, MgB₇, NaB₆, NaB₁₅, NaB₁₆, Na₄C₃, Li₄C₃, K₄C₃, LiC LiC₆, Mg₂C₃, MgC₂, AlTi₂C, AlTi₃C, AlZrC₂, Al₃Zr₅C, Al₃Zr₂C₄, Al₃Zr₂C₇, KC₄, NaC₄, Ge₄K, GeK, GeK₃, GeLi₃, Ge₅Li₂₂, Mg₂Ge, Ge₄Na, GeNa, GeNa₃, Ca₂Si, CaSi, CaSi₂, KSi, K₄Si₂₃, Li₂₂Si₅, Li₁₃Si₄, Li₇Si₃, Li₁₂Si₇, Mg₂Si, NaSi, NaSi₂, or Na₄Si₂₃. In one embodiment, the storage material includes at least two of AlLi, Al₂Li₃, Al₄Li₉, Al₃Mg₂, Al₁₂Mg₁₇, AlB₁₂, Al₄C₃, AlTi₂C, AlTi₃C, AlZrC₂, Al₃Zr₅C, Al₃Zr₂C₄, Al₃Zr₂C₇, AlB₂, AlB₁₂, AlSi, B₆Ca, B₆K, B₁₂Li, B₆Li, B₄Li, B₃Li, B₂Li, BLi, B₆Li₇, BLi₃, MgB₂, MgB₄, MgB₇, NaB₆, NaB₁₅, NaB₁₆, Na₄C₃, Li₄C₃, K₄C₃, LiC, LiC₆, Mg₂C₃, MgC₂, AlTi₂C, AlTi₃C, AlZrC₂, Al₃Zr₅C, Al₃Zr₂C₄, Al₃Zr₂C₇, KC₄, NaC₄, Ge₄K, GeK, GeK₃, GeLi₃, Ge₅Li₂₂, Mg₂Ge, Ge₄Na, GeNa, GeNa₃, Ca₂Si, CaSi, CaSi₂, KSi, K₄Si₂₃, Li₂₂Si₅, Li₁₃Si₄, Li₇Si₃, Li₂₂Si₇, Mg₂Si, NaSi, NaSi₂, or Na₄Si₂₃. By combining at least two of the storage materials the uptake and release rate of the overall composition may be controlled. That is, each of the listed suitable storage materials may have a hydrogen uptake and/or release rate, which may be temperature dependent, particular to that storage material. Thus, control of the overall uptake and or release rate may be obtained by blending the storage materials in determined amounts.

Some of the storage materials release stored hydrogen at the same rate as other of the storage materials, but at differing temperatures. To achieve the same hydrogen release rate for one material, a release rate temperature of 100 degrees Celsius may be necessary, and to achieve the same release rate for another material, the release rate temperature may be 150 degrees Celsius. To achieve a combined composition that has about the same release rate at temperatures ranging from 100 degrees Celsius to 150 degrees Celsius, a blend of the first and second storage materials may be used. In a similar manner, one storage material may store relatively less hydrogen than another storage material but may give up the hydrogen faster or at lower temperatures. Thus, a combination of these materials may provide a release rate profile for the combined composition that provides more hydrogen sooner and at lower temperatures (from the first storage material), and still have a longer duration or amount of provided hydrogen (from the second storage material) relative to a single composition system.

Each aluminum-containing composition, boron-containing composition, carbon-containing composition, germanium-containing composition, and silicon-containing composition may be used in the absence of each other of the compositions. In one embodiment, each aluminum-containing composition, boron-containing composition, carbon-containing composition, germanium-containing composition, and silicon-containing composition may be combined with one or more of the other aluminum-containing compositions, boron-containing compositions, carbon-containing compositions, germanium-containing compositions, and silicon-containing compositions listed herein above.

The storage material may include an oxide. Suitable oxides may include one or more of silica, alumina, ceria, titania, zirconia, tungsten oxide, or vanadium pentoxide. In one embodiment, the oxides may be metal oxides. Suitable metal oxides may include, for example, one or more of tungsten oxide (WO₃), nickel oxide (NiO₂), cobalt oxides (CoO₂), manganese oxides (Mn₂O₄ and MnO₂), vanadium oxides (VO₂ and V₂O₅), molybdenum oxide (MoO₂), or the like.

The storage material may be a monolithic structure, or may be a plurality of particulate. The particulates may be free-flowing or may be agglomerate. The monolith may be porous, and in one embodiment may have a zeolite-like structure. Porous monolith structures are characterized in that the pores are microporous, are nanoporous, or the pores may have differing diameters that include micro and nano-scale pores.

In one embodiment, the storage composition may be formed as a plurality of particles. The particles may be microparticles or may be nanoparticles. The nanoparticles may have an average particle diameter that is in a range of from about 1 nanometer to about 10 nanometers, from about 10 nanometers to about 50 nanometers, from about 50 nanometers to about 75 nanometers, from about 75 nanometers to about 100 nanometers, from about 100 nanometers to about 125 nanometers, from about 125 nanometers to about 200 nanometers, from about 200 nanometers to about 500 nanometers, or from about 500 nanometers to about 1 micrometer. The microparticles may have an average particle diameter that is in a range of from about 1 micrometer to about 10 micrometers, from about 10 micrometers to about 50 micrometers, from about 50 micrometers to about 75 micrometers, from about 75 micrometers to about 100 micrometers, from about 100 micrometers to about 125 micrometers, from about 125 micrometers to about 200 micrometers, from about 200 micrometers to about 500 micrometers, or greater than about 500 micrometers.

The storage material, be it monolith, agglomerate, or particle powder may have a surface area that is greater than or equal to about 10 m²/gm. In one embodiment, the storage material may have a surface area of greater than or equal to about 50 m²/gm. In another embodiment, the storage material may have a surface area of greater than or equal to about 100 m²/gm.

The particle size distribution for powder and for agglomerate may be very narrow in one embodiment, and close to about 1. However, in one embodiment the particle size distribution is multi-modal. For example, for closer packing and higher densities a bi-modal particle size distribution may be used with both nanoparticles and microparticles. Additionally, the particles may be shaped to achieve a particular packing orientation. Suitable particle shapes include spheres, spheroids, rods, cones, irregular shapes, plates, and combinations of the foregoing.

The composition of the storage material may include a catalyst composition. The catalyst composition may be disposed on an outer surface of the storage material, may be dispersed within the storage material, or both. If two or more catalysts are used, they may be disposed of together or one may be dispersed within and the other deposited on the surface thereof.

In one embodiment, the catalyst material comprises one or more of calcium, barium, titanium, chromium, manganese, iron, cobalt, copper, silicon, germanium, rhodium, rhodium, ruthenium, molybdenum, niobium, zirconium, yttrium, barium, lanthanum, hafnium, tungsten, rhenium, osmium, or iridium. In one embodiment, the catalyst material consists essentially of one of calcium, barium, titanium, chromium, manganese, iron, cobalt, copper, silicon, germanium, rhodium, rhodium, ruthenium, molybdenum, niobium, zirconium, yttrium, barium, lanthanum, hafnium, tungsten, rhenium, osmium, or iridium.

The catalyst composition may be an alloy in one embodiment. Suitable alloys may include two or more of calcium, barium, platinum, palladium, nickel, titanium, chromium, manganese, iron, cobalt, copper, silicon, germanium, rhodium, rhodium, ruthenium, molybdenum, niobium, zirconium, yttrium, barium, lanthanum, hafnium, tungsten, rhenium, osmium, or iridium.

The catalyst materials may include one or more metal. Suitable catalysts metals may include barium, calcium, chromium, cobalt, copper, hafnium, iron, iridium, germanium, lanthanum, manganese, molybdenum, nickel, niobium, osmium, palladium, platinum, rhenium, rhodium, ruthenium, silicon, titanium, tungsten, yttrium, zirconium, or a combination including at least one of the foregoing metals. Alloys of these metals may also be used. In one embodiment, the catalyst composition consists essentially of barium, calcium, chromium, cobalt, copper, iron, germanium, hafnium, iridium, lanthanum, manganese, molybdenum, niobium, osmium, rhenium, rhodium, ruthenium, silicon, titanium, tungsten, yttrium, or zirconium.

In one embodiment, the catalyst alloy may contain platinum. In another embodiment, the catalyst alloy may contain palladium. In one embodiment, the catalyst alloy may contain nickel. Suitable examples of metals that may be alloyed with either platinum and/or palladium and/or nickel for the dissociation of molecular hydrogen into atomic hydrogen may be barium, calcium, chromium, cobalt, copper, iron, germanium, hafnium, iridium, lanthanum, manganese, molybdenum, niobium, osmium, rhenium, rhodium, ruthenium, silicon, titanium, tungsten, yttrium, or zirconium or a combination including at least two of the foregoing metals.

The platinum and/or palladium and/or nickel may be present in an amount in a range of from about 0.1 weight percent to about 0.75 weight percent, from about 0.75 weight percent to about 1 weight percent, from about 1 weight percent to about 5 weight percent, from about 5 weight percent to about 7.5 weight percent, from about 7.5 weight percent to about 10 weight percent, from about 10 weight percent to about 15 weight percent, from about 15 weight percent to about 25 weight percent, from about 25 weight percent to about 30 weight percent, from about 30 weight percent to about 45 weight percent, from about 45 weight percent to about 50 weight percent, from about 50 weight percent to about 55 weight percent, from about 55 weight percent to about 65 weight percent, from about 65 weight percent to about 75 weight percent, or greater than about 75 weight percent based on the total weight of the catalyst composition.

The catalyst composition may be about deposited onto the storage material via sputtering, chemical vapor deposition, from solution, or the like. In one embodiment, the catalyst composition may cover a surface area of about 1 percent of the total surface area of the storage composition. In one embodiment, the catalyst composition may cover all the surface area of the storage composition. In one embodiment, the amount of surface area covered by the catalyst composition is in a range of from about 1 percent to about 5 percent, from about 5 percent to about 7 percent, from about 7 percent to about 12 percent, from about 12 percent to about 15 percent, from about 15 percent to about 25 percent, from about 25 percent to about 30 percent, from about 30 percent to about 45 percent, from about 45 percent to about 50 percent, from about 50 percent to about 55 percent, from about 55 percent to about 75 percent, from about 75 percent to about 85 percent, from about 85 percent to about 90 percent, from about 90 percent to about 95 percent, or from about 95 percent to about 99 percent.

When the catalyst composition does not cover 100 percent of the surface area of the storage composition, it may be desirable for the catalyst composition to be disposed onto the surface of the storage composition as isolated particulates or as a discontinuous layer. There may be about no particular limitation to the shape of the particles, which may be for example, spherical, irregular, plate-like or whisker like. Bimodal or higher particle size distributions may also be used. The particulates of the catalyst composition may have radii of gyration of about 1 nanometer to about 500 nanometers (nm). In one embodiment, the radii of gyration may be in a range of from about 1 nanometer to about 10 nanometers, from about 10 nanometers to about 50 nanometers, from about 50 nanometers to about 75 nanometers, from about 75 nanometers to about 100 nanometers, from about 100 nanometers to about 125 nanometers, from about 125 nanometers to about 200 nanometers, from about 200 nanometers to about 500 nanometers, or from about 500 nanometers to about 1 micrometer.

The discontinuous layer of catalyst composition may have an average thickness in a range of in a range of from about 1 nanometer to about 10 nanometers, from about 10 nanometers to about 50 nanometers, from about 50 nanometers to about 75 nanometers, from about 75 nanometers to about 100 nanometers, from about 100 nanometers to about 125 nanometers, from about 125 nanometers to about 200 nanometers, from about 200 nanometers to about 500 nanometers, or from about 500 nanometers to about 1 micrometer. The discontinuities, or holes, in the layer may be regular or irregularly shaped and sized.

In another embodiment, the nanoparticles and microparticles of the storage composition with the catalyst composition disposed upon them may be fused together under pressure to form the hydrogen storage composition. The storage composition to be present in an amount of about 30 weight percent to about 99 weight percent based on the total weight of the hydrogen storage composition. Within this range, the storage composition to be present in an amount of greater than or equal to about 35, greater than or equal to about 40, and greater than or equal to about 45 weight percent of the total weight of the hydrogen storage composition. Within this range, the storage composition to be present in an amount of less than or equal to about 95, greater than or equal to about 90, and greater than or equal to about 85 weight percent of the total weight of the hydrogen storage composition.

Dopants may be included in the storage material. Suitable dopants include, for example, aluminum, cobalt, gallium, germanium, lanthanum, manganese, nickel, silicon, titanium, vanadium, yttrium, zirconium and the elements from the lanthanide series. While catalysts are added concurrent with, or subsequent to, formation of the composition, as used herein dopants are only added during composition formation, may be metallurgically reacted with the storage material, and homogeneously dispersed throughout the storage material. The dopant may be added in an amount of up to about 20 weight percent of the total hydrogen storage composition prior to the storage of hydrogen. It may be desirable to add the dopant in an amount of less than or equal to about 15 weight percent, less than or equal to about 10 weight percent and less than or equal to about 5 weight percent of the total weight of the storage material. In one embodiment, the storage material may include one or more of aluminum doped Ge₄K, aluminum doped GeK, aluminum doped GeK₃, aluminum doped GeLi₃, aluminum doped Ge₅Li₂₂, aluminum doped Mg₂Ge, aluminum doped Ge₄Na, aluminum doped GeNa, or aluminum doped GeNa₃.

In one embodiment, the storage article may include light metal borides. The storage article according to an embodiment of the invention may include one or more compositions of the formula (I) in hydrogen to form a hydrogenated composition:
(Liₐ, Na_{b}, K_{c}, Al_{d}, Mgₑ, Ca_{f})ₓ(B)_{y} (I)
where Li is lithium, Na is sodium, Mg is magnesium, K is potassium, Ca is calcium, Al is aluminum; B is boron; a, b, c, d, e and f are the same or different from each other, and may have a value 0 or 1; and x and y may have a value of 1 to about 22.

In one embodiment, the storage article may include light metal carbides. The light metals may be alkali metals and/or alkaline earth metals. In one embodiment, the light metals may be lithium, sodium, magnesium, potassium, aluminum and calcium. Suitable carbides may have the formula (II):
(Li_{a,} Na_{b}, K_{c}, Al_{d}, Mgₑ, Ca_{f})ₓ(C)_{y} (II)
where Li is lithium, Na is sodium, Mg is magnesium, K is potassium, Ca is calcium, Al is aluminum; B is boron, C is carbon, Si is silicon; a, b, c, d, e and f are the same or different from each other, and may have a value 0 or 1; and x and y may have a value of 1 to about 22. The sum of a+b+c+d+e+f is equal to 1.

In one embodiment, the storage article may include light metal aluminides or germanides. The storage article may include a storage material having the formula (III) or formula (IV):
(Liₐ, Na_{b}, Mg_{c}, K_{d}, Caₑ, Ge_{f})ₓ(Al)_{y} (III)
(Liₐ, Na_{b}, Mg_{c}, K_{d}, Caₑ, Al_{f})ₓ(Ge)_{y} (IV)
where Li is lithium, Na is sodium, Mg is magnesium, K is potassium, Ca is calcium, Ge is germanium, Al is aluminum; a, b, c, d, e and f are the same or different from each other, and may have a value 0 or 1; and x and y may have a value of 1 to about 22; wherein at least one phase of the storage article absorbs hydrogen.

In one embodiment, the storage article may include a storage material having the formula (V):
(Liₐ, Na_{b}, K_{c}, Al_{d}, Mgₑ, Ca_{f})ₓ(N, Si)_{y} (V)
where Li is lithium, Na is sodium, Mg is magnesium, K is potassium, Ca is calcium, Al is aluminum, N is nitrogen, and Si is silicon; a, b, c, d, e and f are the same or different from each other, and may have a value 0 or 1; and x and y have values of from 1 to about 22.

The storage article may contact hydrogen to form a hydrogenated composition. In one embodiment, the storage material includes one or more of AlLi, Al₂Li₃, Al₄Li₉, Al₃Mg₂, Al₁₂Mg₁₇, AlB₁₂, Ge₄K, GeK, GeK₃, GeLi₃, Ge₅Li₂₂, Mg₂Ge, Ge₄Na, GeNa, GeNa₃, aluminum doped Ge₄K, aluminum doped GeK, aluminum doped GeK₃, aluminum doped GeLi₃, aluminum doped Ge₅Li₂₂, aluminum doped Mg₂Ge, aluminum doped Ge₄Na, aluminum doped GeNa, aluminum doped GeNa₃, or a combination including at least two of the foregoing compositions.

Hydride complexes include a H-M complex, where M is a metal and H is hydrogen. Such hydrides may have ionic, covalent, metallic bonding or bonding including a combination of at least one of the foregoing types of bonding. These hydrides have a hydrogen to metal ratio of greater than or equal to 1. The reaction between a metal and hydrogen to form a hydride may be a reversible reaction and takes place according to the following equation (VI):
M+(x/2)H₂ [symbol] MHx (VI)

Hydride complexes can store up to 18 weight percent (weight percent) of hydrogen, and have high volumetric storage densities. The volumetric storage density of hydrides may be greater than either liquid or solid hydrogen, which makes them very useful in energy storage applications. The process of hydrogen adsorption, absorption or chemisorption results in hydrogen storage and may be hereinafter referred to as absorption, while the process of desorption results in the release of hydrogen.

The storage article may be prepared by placing reactants in a substrate. The substrate may be heat treated to promote interdiffusion of the reactants with one another and/or interdiffusion between the reactants with the substrate. After cooling, the resultant article may be subjected to cutting, polishing and grinding. The storage article can be contacted with hydrogen, or a hydrogen rich gaseous mixture, to absorb hydrogen. In one embodiment, the hydrogen storage material is operable to absorb and/or store hydrogen at about room temperature, and at temperatures higher than room temperature. That is, at least some embodiments are not cryogenically adsorbing and/or storing hydrogen even though the hydrogen may be stored at relatively lower temperatures.

In one embodiment, the storage article may be prepared from a pre-form. The pre-form production is initiated by drilling holes into a graphite substrate! These holes end half-way through the thickness of the substrate. Some holes may be spaced apart from one another such that during the heat treatment, there may be about only one reactant reacting with the substrate material to form binary couples and binary solid solutions. When the substrate includes boron carbide (B₄C), ternary triples may be formed because of the presence of boron and carbon in the substrate. In another manner of making a ternary triple, holes may be spaced in close proximity in pairs with each other. This arrangement, i.e., where the holes may be spaced in close proximity in pairs may be used to generate ternary diffusion triples (also termed ternary compositions and/or ternary solid solutions) upon subjecting the storage article to heat treatment. The reactants may be placed into the holes in a loose form i.e., they do not need to be a tight fit but can be fitted tightly if desired.

When the substrate includes a single element, the number of holes drilled in the substrate may be about equal to the minimum number of storage articles desired. Thus for example, if a binary diffusion couple may be about desired in a substrate made from a single element such as graphite, one hole may be about drilled into the substrate, while if a ternary diffusion triple may be about desired, two holes may be drilled into the substrate in close proximity to one another. As stated above, another method of making a ternary triple includes drilling a single hole into a substrate, wherein the substrate may be about made up of an alloy having two reactants. The holes may be greater than about 1 millimeter.

The distance “d” between the holes in the substrate may be about maintained as close as possible for those drilled in pairs. The distance d may be about 0.1 micrometers to about 1 micrometer, from about 1 micrometer to about 10 micrometers, from about 10 micrometers to about 50 micrometers, from about 50 micrometers to about 75 micrometers, from about 75 micrometers to about 100 micrometers, from about 100 micrometers to about 125 micrometers, from about 125 micrometers to about 200 micrometers, from about 200 micrometers to about 500 micrometers, from about 500 micrometers to about 1000 micrometers, from about 1000 micrometers to about 2000 micrometers, from about 2000 micrometers to about 3000 micrometers, or greater than about 3000 micrometers.

In one embodiment, the storage article pre-form includes the graphite substrate with the alkali metals and/or the alkaline earth metals in the holes. The substrate has a diameter of 2.0 inches and the holes containing the reactants may be drilled to a depth of 0.5 inch. The reactants selected for placement in the holes in the substrate may be potassium, lithium, sodium, magnesium, aluminum and calcium. The reactants of magnesium, lithium and aluminum may be placed into individual holes in the substrate. These may be used to prepare binary storage material (a binary diffusion coupling of the reactants with graphite).

Ternary storage material (a diffusion triple of the reactants) may be prepared by drilling the appropriate number holes proximate to each other. Suitable ternary triples may be obtained from, for example, lithium and aluminum with carbon, lithium and magnesium with carbon, and magnesium and aluminum with carbon.

The light metals may be placed into the hole in the substrate in a pure argon environment. The amount of light-element in each hole may be less than a quarter of the volume of the hole such that there will be no pure light element left after the interdiffusion/heat treatment step. The storage article pre-form having the graphite substrate with the light-elements in the holes may be transferred to a furnace or a reactor. The furnace or reactor may be in a vacuum or in a protective environment. Suitable protective environments include inert gas blankets, such as nitrogen, helium, or argon. The block may be heated to an elevated temperature to allow significant interdiffusion to take place among the elements in the holes and the graphite substrate.

The storage article pre-form may be heat treated to a temperature in a range of from about 500 degrees Celsius to about 1000 degrees Celsius. The temperature melts the reactants or their eutectic compositions. Because the melt temperatures, the reactions temperatures, and the degree of desired interdiffusion differs from embodiment to embodiment, the process conditions are determined on a case-by-case basis. In one embodiment, the temperature for heat treatment may be about 670 degrees Celsius.

The heat treatment may be about conducted in a convection furnace, or using radiant heating and/or conductive heating. The molten reactants diffuse and react with the graphite substrate to form storage materials, doped phases, and solid-solution compositions. In one embodiment, the time period of the heat treatment of the storage article assembly may be in a range of from about 5 hours to about 100 hours.

After the heat treatment of the prepared pre-form to form the storage article, a slicing operation may be performed on the storage article. The slicing step may expose different compositions/solid solutions formed at different locations of the storage article assembly. The slicing operation may be about performed using mechanical cutting using a saw or wire discharge electro-machining (EDM). Following slicing, the respective slices may be ground and polished. Following the optional grinding and polishing operation, the samples may be subjected to electron microprobe analysis and electron backscatter diffraction (EBSD) analysis to identify the phases and compositions.

After the electron microprobe and EBSD analysis of the light metal carbides, the resulting storage article storage material may be converted to hydrides by exposure to hydrogen or upon hydrogenation. In one embodiment, the presence of the potassium, lithium, magnesium and sodium promotes an affinity for hydrogen. Carbon may have a relatively low affinity for the hydrogen and this feature may be about offset by the affinity of hydrogen displayed by potassium, lithium, magnesium and/or sodium.

The storage article may include one or more of the light metal carbides, borocarbides, carbonitrides, aluminides, borides, germanides, or silicides. The article can absorb and desorb hydrogen. In one embodiment, the composition gradients formed during the preparation of a storage article can serve as a combinatorial library to determine which specific composition can absorb and desorb hydrogen.

The ability of a light metal storage article to reversibly absorb and desorb hydrogen may be detected by a variety of analytical techniques. In general, the process of absorption of hydrogen into the carbides results in a change in appearance because of a crystal structure change and/or a volumetric expansion. In addition, the adsorption of hydrogen into the carbides may be about accompanied by an exotherm, while the desorption of the hydrogen may be about accomplished by the application of heat. The analytical techniques that can be used to measure the changes in the storage articles may be time of flight secondary mass ion spectrometry (ToF-SIMS), tungsten oxide (WO₃) coatings and thermography. In addition, the carbides can be screened by observing the storage article after hydrogenation, since the phases that do undergo hydrogenation (i.e., hydrides) become pulverized.

The ToF-SIMS has the capability to detect the adsorption and desorption of hydrogen. This technique can operate at temperatures of about negative 100 degrees Celsius to about 600 degrees Celsius, has a high sensitivity to hydrogen and may be a useful tool for investigating the combinatorial libraries generated by the storage articles. The ToF-SIMS maps the adsorption temperatures and the reaction conditions during the hydrogenation process.

Tungsten oxide (WO₃) changes its color when it reacts with hydrogen. The storage article may be coated with WO₃. The coating may be performed prior or subsequent to the hydrogenation reaction. When the storage article is heated to the release temperature of the particular storage material to release the hydrogen, the WO₃ changes color as the hydrogen desorbs from the storage article.

Thermography or thermal imaging (infrared imaging) may determine the adsorption and desorption of hydrogen. When a phase in the storage article absorbs hydrogen, the local temperature rises. When the phase desorbs hydrogen, the local temperature decreases. Thermography can indicate hydrogen adsorption.

In one embodiment, the storage materials can be hydrogenated by subjecting them to a mixture of gases including hydrogen. The storage material may release heat during the absorption of hydrogen. The hydrogen may then be released by reducing the pressure and supplying heat to the hydrogenated storage materials. Desorption of hydrogen may require thermal cycles. Such thermal cycles can be obtained by the application of electromagnetic fields or by passing electrical current through the storage material. This can be accomplished because most hydrogenated storage materials may be electrically conductive. The resistance of these materials may change with the extent of hydrogen storage.

In one embodiment, electromagnetic fields may desorb stored hydrogen. Microwave energy can be applied to the hydrogenated storage materials or to a suitable medium such as water, alcohols, or the like, intermixed with the hydrogenated storage materials to allow for the local release of hydrogen under controlled conditions, without heating the whole system. This method provides a high efficiency of desorption, which occurs at temperatures lower than those achieved due to heating brought about by conduction and/or convection. This phenomena occurs due to a local excitation of the bonds in the storage materials by the microwaves. The desorption may be conducted by two different methods. The first of these methods includes using microwaves to achieve a release of the entire hydrogen content. The second method includes using a microwave treatment to initialize the desorption process which then can be continued by either conductive and/or convective heating at lower temperatures and in a much easier manner than when heated by only conductive and/or convective heat from the start of the process.

In one embodiment, hydrogen desorption can be induced by the heat generated by an electrical resistor embedded in the storage materials. The energy of the current flowing into the resistor may be about converted into heat by the Joule effect. The amount of heat created locally by the current flow may be about particularly high in the case of a compressed powdered storage materials, with hot spots occurring on the current paths between powder particles, where the resistivity may be about very high. In extreme cases, powder welding may occur at the hot spots. Therefore, the current parameters should be adjusted properly to avoid sintering or powder welding. Depending on the conditions of the process, the carbides may be heated directly, or by the use of multiple resistors as detailed above.

In one embodiment, hydrogen absorption and desorption may be about accomplished by mixing fine particles of the storage materials with an appropriate amount of another chemical composition that has a higher thermal conductivity to conduct heat faster to the hydrogenated composition for hydrogen release. In one embodiment, hydrogen desorption may be about accomplished by using the exhaust heat released from the proton exchange membrane (PEM) fuel cells to heat up the hydrogenated storage materials.

The hydrogen desorbed from these storage materials can be greater than about 1 weight percent based on the total weight of the storage material less the stored hydrogen. In one embodiment, the amount of stored hydrogen may be in a range of from about 1 weight percent to about 2 weight percent, from about 2 weight percent to about 3 weight percent, from about 3 weight percent to about 4 weight percent, from about 4 weight percent to about 4.25 weight percent, from about 4.25 weight percent to about 4.5 weight percent, from about 4.5 weight percent to about 4.75 weight percent, from about 4.75 weight percent to about 5 weight percent, from about 5 weight percent to about 5.5 weight percent, from about 5.5 weight percent to about 6 weight percent, from about 6 weight percent to about 6.5 weight percent, from about 6.5 weight percent to about 7 weight percent, from about 7 weight percent to about 7.25 weight percent, from about 7.25 weight percent to about 7.5 weight percent, from about 7.5 weight percent to about 8 weight percent, or greater than about 8 weight percent based on the total weight of the storage material less the stored hydrogen.

One method of producing hydrogen from hydrides of the storage materials includes a slurry production reactor upstream of and in fluid communication with a hydrogen generation reactor. The slurry production reactor regenerates a metal hydride slurry in the hydrogen generation reactor. At least a portion of the metal hydride in the hydrogen generation reactor may oxidized to a metal hydroxide during the recovery of hydrogen from the light metal hydrides. The hydrogen generation reactor utilizes one or more of electromagnetic radiation, convectional heating, PEM fuel cell exhaust, and the like to heat the hydride for the generation of hydrogen. The hydrogen generation reactor may be upstream of, and in fluid communication with, an drying and separation reactor and the metal hydroxide may transfer to the drying and separation reactor. At least a portion of metal hydroxide generated in the hydrogen generation reactor may recycle to the drying and separation unit. The hydrogen generation reactor may supply water, if and where needed. The drying and separation reactor separates reusable fluids from the metal hydroxides and recycles the fluid to the slurry production reactor. The system includes a hydride recycle reactor in fluid communication with, and downstream of, the drying and separation unit. Dry metal hydroxide from the drying and separation reactor may regenerate into a metal hydride in the hydride recycle reactor by contacting it with hydrogen gas. The hydride recycle reactor may supply with carbon and oxygen in amounts effective to regenerate the metal hydride. The regenerated metal hydride may recycle to the slurry production reactor for mixing with the recycled carrier liquids.

As noted hereinabove, hydrogen desorption can be induced by heating the storage composition using an electrical resistor embedded in the composition. The energy of the current flowing into the resistor may convert to heat by the Joule effect. The amount of heat locally created by the current flow may be particularly high in the case of a compressed powder storage composition. Hot spots may form on an electrical current path between powder particles where the resistivity may be relatively high. In some cases, powder or particulate welding may occur at the hot spot. Current parameters may be controlled to avoid or facilitate sintering. In one embodiment, multiple resistors may be used to heat the storage material.

Applying ultrasonic energy to the storage material may induce hydrogen desorption. The storage material may be disposed in a liquid such as water or alcohol. By using liquids such as water or alcohol as energy carrier mediums, shock waves may be generated. The shock waves may cause localized heating through acoustic cavitation. The acoustic cavitation forms hot spots. The hot spots may reach temperatures of up to 5000 Kelvin over periods of less than 1 microsecond. The formation of such hot spots having such elevated temperatures may desorp stored hydrogen. This method provides for a relatively efficient hydrogen recovery process.

The storage material, and the storage article, may be used in conjunction with energy generating devices such as fuel cells, gas turbines, or the like. The hydrogen storage material may be used in an automobile, a train, a ship, submarine, airplane, rocket, space station, and the like.

The foregoing examples and embodiments illustrate some features of the invention. The appended claims claim the invention as broadly as has been conceived and the examples herein presented may be illustrative of selected embodiments from a manifold of all possible embodiments. Accordingly, the appended claims are not limited to the illustrated features of the invention by the choice of examples utilized. As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges may be inclusive of all sub-ranges there between. It may be about to be expected that variations in these ranges will suggest themselves to a practitioner having ordinary skill in the art and, where not already dedicated to the public, the appended claims should cover those variations. Advances in science and technology may make equivalents and substitutions possible that may be not now contemplated by reason of the imprecision of language; these variations are covered by the appended claims.

Reference is made to substances, components, or ingredients in existence at the time just before first contacted, formed in situ, blended, or mixed with one or more other substances, components, or ingredients in accordance with the present disclosure. A substance, component or ingredient identified as a reaction product, resulting mixture, or the like may gain an identity, property, or character through a chemical reaction or transformation during the course of contacting, in situ formation, blending, or mixing operation if conducted in accordance with this disclosure with the application of common sense and the ordinary skill of one in the relevant art (e.g., chemist). The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product or final material.

The embodiments described herein may be examples of compositions, structures, systems, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes compositions, structures, systems and methods that do not differ from the literal language of the claims, and further includes other structures, systems and methods with insubstantial differences from the literal language of the claims. While only certain features and embodiments have been illustrated and described herein, many modifications and changes may occur to one of ordinary skill in the relevant art. The appended claims cover all such modifications and changes.

1. A composition, comprising:
a storage material comprising at least one of AlLi, Al₂Li₃, Al₄Li₉, Al₃Mg₂, Al₁₂Mg₁₇, AlB₁₂, Al₄C₃, AlTi₂C, AlTi₃C, AlZrC₂, Al₃Zr₅C, Al₃Zr₂C₄, Al₃Zr₂C₇, AlB₂, AlB₁₂, AlSi, B₆Ca, B₆K, B₁₂Li, B₆Li, B₄Li, B₃Li, B₂Li, BLi, B₆Li₇, BLi₃, Ca₂Si, CaSi, CaSi₂, Ge₄K, GeK, GeK₃, GeLi₃, Ge₅Li₂₂, Mg₂Ge, Ge₄Na, GeNa, GeNa₃, KSi, KC₄, K₄Si₂₃, K₄C₃, LiC, Li₄C₃, LiC₆, Li₂₂Si₅, Li₁₃Si₄, Li₇Si₃, Li₁₂Si₇, MgB₂, MgB₄, MgB₇, MgC₂, Mg₂C₃, Mg₂Si, NaB₆, NaB₁₅, NaB₁₆, Na₄C₃, NaC₄, NaSi, NaSi₂, or Na₄Si₂₃.

2. The composition as defined in claim 1, wherein the storage material comprises at least two of AlLi, Al₂Li₃, Al₄Li₉, Al₃Mg₂, Al₁₂Mg₁₇, AlB₁₂, Al₄C₃, AlTi₂C, AlTi₃C, AlZrC₂, Al₃Zr₅C, Al₃Zr₂C₄, Al₃Zr₂C₇, AlB₂, AlB₁₂, AlSi, B₆Ca, B₆K, B₁₂Li, B₆Li, B₄Li, B₃Li, B₂Li, BLi, B₆Li₇, BLi₃, Ca₂Si, CaSi, CaSi₂, Ge₄K, GeK, GeK₃, GeLi₃, Ge₅Li₂₂, Mg₂Ge, Ge₄Na, GeNa, GeNa₃, KSi, KC₄, K₄Si₂₃, K₄C₃, LiC, Li₄C₃, LiC₆, Li₂₂Si₅, Li₁₃Si₄, Li₇Si₃, Li₁₂Si₇, MgB₂, MgB₄, MgB₇, MgC₂, Mg₂C₃, Mg₂Si, NaB₆, NaB₁₅, NaB₁₆, Na₄C₃, NaC₄, NaSi, NaSi₂, or Na₄Si₂₃.

3. The composition as defined in claim 1, further comprising an oxide material.

4. The composition as defined in claim 3, wherein the oxide material is selected from the group consisting of silica, alumina, ceria, titania, zirconia, tungsten oxide, and vanadium pentoxide.

5. The composition as defined in claim 3, where the oxide is a metal oxide.

6. The composition as defined in claim 5, wherein the metal oxide comprises one or more material selected from the group consisting of tungsten oxide, nickel oxide, cobalt oxide, manganese oxide, vanadium oxide, and molybdenum oxide.

7. The composition as defined in claim 1, further comprising a catalyst composition.

8. The composition as defined in claim 7, wherein the catalyst composition comprises one or more element of barium, calcium, chromium, cobalt, copper, iron, germanium, hafnium, iridium, lanthanum, manganese, molybdenum, niobium, osmium, rhenium, rhodium, ruthenium, silicon, titanium, tungsten, yttrium, or zirconium.

9. The composition as defined in claim 8, wherein the catalyst composition consists essentially of a single element selected from the group consisting of barium, calcium, chromium, cobalt, copper, iron, germanium, hafnium, iridium, lanthanum, manganese, molybdenum, niobium, osmium, rhenium, rhodium, ruthenium, silicon, titanium, tungsten, yttrium, or zirconium.

10. The composition as defined in claim 7, wherein the catalyst composition is present in an amount that is greater than about 0.1 weight percent based on the total weigth of the composition.

11. The composition as defined in claim 7, wherein the catalyst composition is present in an amount that is less than about 5 weight percent based on the total weigth of the composition.

12. The composition as defined in claim 7, wherein the catalyst composition defines a catalyst layer overlaying a surface of the storage material.

13. The composition as defined in claim 12, wherein the catalyst layer has an average thickness that is less than 1 micrometer.

14. The composition as defined in claim 13, wherein the catalyst layer has an average thickness in a range of in a range of from about 1 nanometer to about 10 nanometers.

15. The composition as defined in claim 12, wherein the catalyst layer is a discontinuous layer.

16. The composition as defined in claim 15, wherein the catalyst layer covers from about 10 percent to about 50 percent of the surface of the storage material.

17. The composition as defined in claim 1, further comprising a dopant selected from the elemental group consisting of aluminum, cobalt, gallium, germanium, lanthanum, manganese, nickel, silicon, titanium, vanadium, yttrium, and zirconium.

18. The composition as defined in claim 17, wherein the storage material comprises one or more of aluminum doped Ge₄K, aluminum doped GeK, aluminum doped GeK₃, aluminum doped GeLi₃, aluminum doped Ge₅Li₂₂, aluminum doped Mg₂Ge, aluminum doped Ge₄Na, aluminum doped GeNa, or aluminum doped GeNa₃.

19. The composition as defined in claim 1, wherein the storage material is a porous monolith.

20. The composition as defined in claim 1, wherein the storage material is a powder.

21. The composition as defined in claim 20, wherein the powder has a surface area of greater than about 50 square meters per gram.

22. The composition as defined in claim 20, wherein the powder comprises a plurality of particles having an average particle size of less than 100 nanometers.

23. The composition as defined in claim 20, wherein the powder comprises a plurality of particles having a bimodal particle distribution.

24. The composition as defined in claim 20, wherein the powder comprises a plurality of particles that are substantially spheriod.

25. A composition, comprising a hydride of the composition as defined in claim 1.

26. An article formed from the composition as defined in claim 1.

27. An article, comprising:
a storage material comprising one or more material having a formula selected from the group consisting of formulae (I), (II), (III), (IV) and (IV), wherein:
(Liₐ, Na_{b}, K_{c}, Al_{d}, Mgₑ, Ca_{f})ₓ(B)_{y} (I)
(Liₐ, Na_{b}, K_{c}, Al_{d}, Mgₑ, Ca_{f})ₓ(C)_{y} (II)
(Liₐ, Na_{b}, Mg_{c}, K_{d}, Caₑ, Ge_{f})ₓ(Al)_{y} (III)
(Liₐ, Na_{b}, Mg_{c}, K_{d}, Caₑ, Al_{f})ₓ(Ge)_{y} (IV)
(Liₐ, Na_{b}, K_{c}, Al_{d}, Mgₑ, Ca_{f})ₓ(N, Si)_{y} (V)
where Al is aluminum, B is boron, C is carbon, Ca is calcium, Ge is germanium, K is potassium, Li is lithium, Mg is magnesium, Na is sodium, N is nitrogen, and Si is silicon;
a, b, c, d, e and f are the same or different from each other, and each independently have a value 0 or 1, provided that the sum a+b+c+d+e+f is 1 or greater; and x and y each independently have a value in a range of from 1 to about 22.

28. A system, comprising:
a storage article comprising a storage material selected from the group consisting of AlLi, Al₂Li₃, Al₄Li₉, Al₃Mg₂, Al₁₂Mg₁₇, AlB₁₂, Al₄C₃, AlTi₂C, AlTi₃C, AlZrC₂, Al₃Zr₅C, Al₃Zr₂C₄, Al₃Zr₂C₇, AlB₂, AlB₁₂, AlSi, B₆Ca, B₆K, B₁₂Li, B₆Li, B₄Li, B₃Li, B₂Li, BLi, B₆Li₇, BLi₃, Ca₂Si, CaSi, CaSi₂, Ge₄K, GeK, GeK₃, GeLi₃, Ge₅Li₂₂, Mg₂Ge, Ge₄Na, GeNa, GeNa₃, KSi, KC₄, K₄Si₂₃, K₄C₃, LiC, Li₄C₃, LiC₆, Li₂₂Si₅, Li₁₃Si₄, Li₇Si₃, Li₁₂Si₇, MgB₂, MgB₄, MgB₇, MgC₂, Mg₂C₃, Mg₂Si, NaB₆, NaB₁₅, NaB₁₆, Na₄C₃, NaC₄, NaSi, NaSi₂, and Na₄Si₂₃; and
means for detection of hydrogen in communication with the storage article.

29. A system, comprising:
a storage article comprising hydrogen and a storage material selected from the group consisting of AlLi, Al₂Li₃, Al₄Li₉, Al₃Mg₂, Al₁₂Mg₁₇, AlB₁₂, Al₄C₃, AlTi₂C, AlTi₃C, AlZrC₂, Al₃Zr₅C, Al₃Zr₂C₄, Al₃Zr₂C₇, AlB₂, AlB₁₂, AlSi, B₆Ca, B₆K, B₁₂Li, B₆Li, B₄Li, B₃Li, B₂Li, BLi, B₆Li₇, BLi₃, Ca₂Si, CaSi, CaSi₂, Ge₄K, GeK, GeK₃, GeLi₃, Ge₅Li₂₂, Mg₂Ge, Ge₄Na, GeNa, GeNa₃, KSi, KC₄, K₄Si₂₃, K₄C₃, LiC, Li₄C₃, LiC₆, Li₂₂Si₅, Li₁₃Si₄, Li₇Si₃, Li₁₂Si₇, MgB₂, MgB₄, MgB₇, MgC₂, Mg₂C₃, Mg₂Si, NaB₆, NaB₁₅, NaB₁₆, Na₄C₃, NaC₄, NaSi, NaSi₂, and Na₄Si₂₃; and
means for desorbing hydrogen in communication with the storage article.
